(19) United States
(12) Patent Application Publication
(10) Pub. No.: US 2013/0045008 A1
(43) Pub. Date: Feb. 21, 2013

(54) Electric Field Measuring Apparatus

(71) Applicants: Norikazu Miyazaki, Chiyoda-ku (JP); Takeshi Sakai, Chiyoda-ku (JP); Masahito Mure, Chiyoda-ku (JP)

(72) Inventors: Norikazu Miyazaki, Chiyoda-ku (JP); Takeshi Sakai, Chiyoda-ku (JP); Masahito Mure, Chiyoda-ku (JP)

(73) Assignee: Sumitomo Osaka Cement Co.,Ltd., Tokyo (JP)

(21) Appl. No.: 13/580,725

(22) PCT Filed: Feb. 21, 2011
(86) PCT No.: PCT/JP2011/053659

§ 371 Date: Nov. 6, 2012

(30) Foreign Application Priority Data
Feb. 23, 2010 (JP) 2010-036770

(51) Int. Cl. H04B 10/08

(52) U.S. Cl. 398/38

(57) ABSTRACT

An electric field measuring apparatus measures electric field intensity of an electromagnetic wave generated from equipment under test installed in an area in which electromagnetic waves are detected. The apparatus includes an antenna, an RF amplifier amplifying an output signal of the antenna, a signal intensity detector detecting whether intensity of the output signal is higher than a predetermined level, a signal generator generating a detection result signal on the basis of a detection result of the signal intensity detector, a multiplexer multiplexing an output signal of the RF amplifier, the detection result signal, and a DC bias voltage, and an optical intensity modulator having a Mach-Zehnder type optical waveguide performing an optical modulation operation on the basis of an output signal of the multiplexer are arranged inside the area. Arranged outside the area are a light source unit, a receiver unit, a DC bias controller, and a display unit.

### TECHNICAL FIELD

The present invention relates to an electric field measuring apparatus, and more particularly, to an electric field measuring apparatus used in analog optical transmission techniques for the field of electromagnetic field measurement such as measuring electromagnetic wave noise radiated from an electronic apparatus or the like, evaluating electromagnetic wave measuring equipment such as an anechoic chamber, and evaluating an antenna.

### BACKGROUND ART

The measurement of radiated electromagnetic wave noise is performed in a measurement environment in which electromagnetic waves other than a measurement target are suppressed using equipment such as an anechoic chamber. Accordingly, a signal received through a receiving antenna in an anechoic chamber is transmitted to a neighboring measuring chamber and measurement is performed on the signal through the use of a measuring instrument installed in the measuring chamber.

With the recent working speed increases in electronic apparatuses, electromagnetic wave noise has increased in frequency and needs to be evaluated at frequencies higher than 1 GHz or 10 GHz in some cases. The applicant of the invention proposed a method of optically transmitting a signal received through a receiving antenna using an optical modulator having a Mach-Zehnder type optical waveguide or an optical fiber transmission apparatus such as an optical fiber in PTL 1.

In many cases, the level of noise radiated from equipment under test is an unexpected level and various measurements are performed using the same equipment. Accordingly, the level range of a signal to be transmitted is very wide and there is an intensity difference of several tens of dB in some cases.

Since components such as an amplifier or an optical modulator causing saturation or distortion in output depending on the input level are used in an optical-fiber transmission apparatus, it is necessary to note the input to the transmission apparatus. Accordingly, in the past, an appropriate attenuator was installed in an input unit inputting a signal from an antenna to a transmission apparatus for measurement while checking the measurement result of a measuring apparatus on whether saturation or distortion due to the level of a signal is present whenever measuring.

The work of checking the output saturation or distortion of a transmission apparatus due to an excessive input signal is very troublesome, the saturation or distortion is overlooked in some cases, and there was thus a possibility of uncertain measurement.

### CITATION LIST

### Patent Literature

[PTL 1] Japanese Patent Application No. 2008-303106 (filing date: Nov. 27, 2008)

### SUMMARY OF INVENTION

### Technical Problem

The invention is made to solve the above-mentioned problems and an object thereof is to provide an electric field measuring apparatus in which an output saturation or distortion state of a transmission apparatus due to an input signal level from an antenna can be easily checked and the measurement of an electric field in equipment such as an anechoic chamber is not hindered by noise from the measuring apparatus.

### Solution to Problem

According to a first aspect of the invention, there is provided an electric field measuring apparatus that measures an electric field intensity of an electromagnetic wave generated from an equipment under test installed in an area in which electromagnetic waves are detected, wherein an antenna, an RF amplifier amplifying an output signal of the antenna, a signal intensity detector detecting whether an intensity of the output signal is higher than a predetermined level, a signal generator generating a detection result signal on the basis of a detection result of the signal intensity detector, a multiplexer multiplexing an output signal of the RF amplifier, the detection result signal, and a DC bias voltage, and an optical intensity modulator having a Mach-Zehnder type optical waveguide performing an optical modulation operation on the basis of an output signal of the multiplexer are arranged inside the area, wherein a light source unit, a receiver unit receiving an output light wave from the optical intensity modulator, a DC bias controller controlling the DC bias voltage supplied to the optical intensity modulator on the basis of a variation in intensity of an output signal of the receiver unit, and a display unit detecting a signal based on the detection result signal from the output signal of the receiver unit and displaying the detection result are arranged outside the area, wherein an optical wave is introduced into the optical intensity modulator from the light source unit through an optical fiber, wherein an optical wave is introduced into the receiver unit from the optical intensity modulator through an optical fiber, and wherein the DC bias voltage is supplied to the optical intensity modulator from the DC bias controller through a power supply line.

According to a second aspect of the invention, there is provided an electric field measuring apparatus that measures an electric field intensity of an electromagnetic wave generated from an equipment under test installed in an area in which electromagnetic waves are detected, wherein an antenna, an RF amplifier amplifying an output signal of the antenna, a signal intensity detector detecting whether an intensity of the output signal is higher than a predetermined level, a signal generator generating a detection result signal on the basis of a detection result of the signal intensity detector, a multiplexer multiplexing an output signal of the RF amplifier, the detection result signal, and a DC bias voltage, an optical intensity modulator having a Mach-Zehnder type optical waveguide performing an optical modulation operation on the basis of an output signal of the multiplexer, a branching unit branching a part of an output light wave from the optical intensity modulator, a first receiver unit receiving a branched light wave branched by the branching unit, a DC bias controller controlling the DC bias voltage supplied to the optical intensity modulator on the basis of a variation in intensity of an output signal of the first receiver unit, and a battery driving at least one of the RF amplifier, the signal intensity detector, the signal generator, the first receiver unit, and the DC bias controller are arranged inside the area, wherein a light source unit, a second receiver unit receiving an output light wave from the optical intensity modulator, and a display unit detecting a signal based on the detection result signal from an output signal of the second receiver unit and displaying the detection result are arranged outside the area, wherein an optical wave is introduced into the optical intensity modulator from the light source unit through an optical fiber, and wherein an optical wave is introduced into the receiver unit from the optical intensity modulator through an optical fiber.

According to a third aspect of the invention, there is provided an electric field measuring apparatus that measures an electric field intensity of an electromagnetic wave generated from an equipment under test installed in an area in which electromagnetic waves are detected, wherein an antenna, an RF amplifier amplifying an output signal of the antenna, a signal intensity detector detecting whether an intensity of the output signal is higher than a predetermined level, a signal generator generating a detection result signal on the basis of a detection result of the signal intensity detector, a multiplexer multiplexing an output signal of the RF amplifier, the detection result signal, and a DC bias voltage, an optical intensity modulator having a Mach-Zehnder type optical waveguide performing an optical modulation operation on the basis of an output signal of the multiplexer, a first receiver unit being built in the optical intensity modulator and monitoring an output optical intensity of the optical intensity modulator, a DC bias controller controlling the DC bias voltage supplied to the optical intensity modulator on the basis of a variation in intensity of an output signal of the first receiver unit, and a battery driving at least one of the RF amplifier, the signal intensity detector, the signal generator, the first receiver unit, and the DC bias controller are arranged inside the area, wherein a light source unit, a second receiver unit receiving an output light wave from the optical intensity modulator, and a display unit detecting a signal based on the detection result signal from an output signal of the second receiver unit and displaying the detection result are arranged outside the area, wherein an optical wave is introduced into the optical intensity modulator from the light source unit through an optical fiber, and wherein an optical wave is introduced into the receiver unit from the optical intensity modulator through an optical fiber.

A fourth aspect of the invention provides the electric field measuring apparatus according to any one of the first to third aspects, wherein the detection result signal has a frequency less than 30 MHz.

A fifth aspect of the invention provides the electric field measuring apparatus according to any one of the first to fourth aspects, further including an attenuator attenuating the intensity of the output signal of the antenna on the basis of the detection result of the signal intensity detector.

A sixth aspect of the invention provides the electric field measuring apparatus according to any one of the first to fourth aspects, further including an RF amplification controller controlling the output of the RF amplifier on the basis of the detection result of the signal intensity detector.

### Advantageous Effects of Invention

According to the first aspect of the invention, in the electric field measuring apparatus that measures an electric field intensity of an electromagnetic wave generated from an equipment under test installed in an area in which electromagnetic waves are detected, an antenna, an RF amplifier amplifying an output signal of the antenna, a signal intensity detector detecting whether an intensity of the output signal is higher than a predetermined level, a signal generator generating a detection result signal on the basis of a detection result of the signal intensity detector, a multiplexer multiplexing an output signal of the RF amplifier, the detection result signal, and a DC bias voltage, and an optical intensity modulator having a Mach-Zehnder type optical waveguide performing an optical modulation operation on the basis of an output signal of the multiplexer are arranged inside the area, a light source unit, a receiver unit receiving an output light wave from the optical intensity modulator, a DC bias controller controlling the DC bias voltage supplied to the optical intensity modulator on the basis of a variation in intensity of an output signal of the receiver unit, and a display unit detecting a signal based on the detection result signal from the output signal of the receiver unit and displaying the detection result are arranged outside the area, an optical wave is introduced into the optical intensity modulator from the light source unit through an optical fiber, an optical wave is introduced into the receiver unit from the optical intensity modulator through an optical fiber, and the DC bias voltage is supplied to the optical intensity modulator from the DC bias controller through a power supply line. Accordingly, it is possible to simply detect the output saturation or distortion of a transmission apparatus, such as an RF amplifier or an optical modulator, due to an excessive input signal level from the antenna. A head unit (constituted by constituents such as an optical modulator other than the antenna) disposed inside the area can measure the signal level from the antenna, and gives an alarm for the input level to a controller unit (constituted by constituents such as the light source unit, the receiver unit, and the DC bias controller disposed outside the area) disposed outside the area when the measured signal level is higher than a given reference, and the controller unit having received the alarm can display the alarm for the input signal level.

Since the detection result signal on the input signal level can be transmitted using the optical transmission system for an RF signal which is the output signal of the antenna, many constituents need not be added. In addition, since optical transmission is used, the surrounding electromagnetic field is not disturbed.

According to the second aspect of the invention, in the electric field measuring apparatus that measures an electric field intensity of an electromagnetic wave generated from equipment under test installed in an area in which electromagnetic waves are detected, an antenna, an RF amplifier amplifying an output signal of the antenna, a signal intensity detector detecting whether an intensity of the output signal is higher than a predetermined level, a signal generator generating a detection result signal on the basis of a detection result of the signal intensity detector, a multiplexer multiplexing an output signal of the RF amplifier, the detection result signal, and a DC bias voltage, an optical intensity modulator having a Mach-Zehnder type optical waveguide performing an optical modulation operation on the basis of an output signal of the multiplexer, a branching unit branching a part of an optical output from the optical intensity modulator, a first receiver unit receiving a branched light wave branched by the branching unit, a DC bias controller controlling the DC bias voltage supplied to the optical intensity modulator on the basis of a variation in intensity of an output signal of the first receiver unit, and a battery driving at least one of the RF amplifier, the signal intensity detector, the signal generator, the first receiver unit, and the DC bias controller are arranged inside the area, a light source unit, a second receiver unit receiving an output light wave from the optical intensity modulator, and a display unit detecting a signal based on the detection result signal from an output signal of the second receiver unit and displaying the detection result are arranged outside the area, an optical wave is introduced into the optical intensity modulator from the light source unit through an optical fiber, and an optical wave is introduced into the receiver unit from the optical intensity modulator through an optical fiber. Accordingly, similarly to the first aspect, it is possible to simply detect the output saturation or distortion of a transmission apparatus, such as an RF amplifier or an optical modulator, due to an excessive input signal level from the antenna. A head unit (constituted by constituents such as an optical modulator other than the antenna) disposed inside the area can measure the signal level from the antenna, and gives an alarm for the input level to a controller unit (constituted by constituents such as the light source unit and the receiver unit disposed outside the area) disposed outside the area when the measured signal level is higher than a given reference, and the controller unit having received the alarm can display the alarm for the input signal level.

Since the detection result signal on the input signal level can be transmitted using the optical transmission system for an RF signal which is the output signal of the antenna, many constituents need not be added. In addition, since optical transmission is used, the surrounding electromagnetic field is not disturbed. Particularly, by disposing inside the area the battery activating at least one of the RF amplifier, the signal intensity detector, the signal generator, the first receiver unit, and the DC bias controller, it is possible to make the power supply line from the outside of the area unnecessary and thus to connect the inside and the outside of the area using only an optical fiber.

According to the third aspect of the invention, in the electric field measuring apparatus that measures an electric field intensity of an electromagnetic wave generated from equipment under test installed in an area in which electromagnetic waves are detected, an antenna, an RF amplifier amplifying an output signal of the antenna, a signal intensity detector detecting whether an intensity of the output signal is higher than a predetermined level, a signal generator generating a detection result signal on the basis of a detection result of the signal intensity detector, a multiplexer multiplexing an output signal of the RF amplifier, the detection result signal, and a DC bias voltage, an optical intensity modulator having a Mach-Zehnder type optical waveguide performing an optical modulation operation on the basis of an output signal of the multiplexer, a first receiver unit being built in the optical intensity modulator and monitoring an output optical intensity of the optical intensity modulator, a DC bias controller controlling the DC bias voltage supplied to the optical intensity modulator on the basis of a variation in intensity of an output signal of the first receiver unit, and a battery driving at least one of the RF amplifier, the signal intensity detector, the signal generator, the first receiver unit, and the DC bias controller are arranged inside the area, a light source unit, a second receiver unit receiving an optical output from the optical intensity modulator, and a display unit detecting a signal based on the detection result signal from an output signal of the second receiver unit and displaying the detection result are arranged outside the area, an optical wave is introduced into the optical intensity modulator from the light source unit through an optical fiber, and an optical wave is introduced into the receiver unit from the optical intensity modulator through an optical fiber. Accordingly, similarly to the first or second aspect, it is possible to simply detect the output saturation or distortion of a transmission apparatus, such as an RF amplifier or an optical modulator, due to an excessive input signal level from the antenna. A head unit (constituted by constituents such as an optical modulator other than the antenna) disposed inside the area can measure the signal level from the antenna, and gives an alarm for the input level to a controller unit (constituted by constituents such as the light source unit and the receiver unit disposed outside the area) disposed outside the area when the measured signal level is higher than a given reference, and the controller unit having received the alarm can display the alarm for the input signal level.

Since the detection result signal on the input signal level can be transmitted using the optical transmission system for an RF signal which is the output signal of the antenna, many constituents need not be added. In addition, since optical transmission is used, the surrounding electromagnetic field is not disturbed. Particularly, by disposing inside the area the battery activating at least one of the RF amplifier, the signal intensity detector, the signal generator, the first receiver unit, and the DC bias controller, it is possible to make the power supply line from the outside of the area unnecessary and thus to connect the inside and the outside of the area using only an optical fiber. Since the first receiver unit is built in the optical intensity modulator, it is possible to compactly construct the head unit disposed in the area and to make the configuration branching a part of the optical output from the optical intensity modulator unnecessary, thereby suppressing the loss of the optical output.

According to the fourth aspect of the invention, since the detection result signal has a frequency less than 30 MHz, it is possible to suppress the cross-talk of electromagnetic wave noise received by the antenna and the detection result signal by optically modulating the detection result signal at a frequency outside the frequency band of the measured radiated electromagnetic noise (equal to or higher than 30 MHz), and it is thus possible to more accurately transmit a signal to the controller unit.

According to the fifth aspect of the invention, since the electric field measuring apparatus further includes an attenuator attenuating the intensity of the output signal of the antenna on the basis of the detection result of the signal intensity detector, the intensity of the output signal of the antenna input to the RF amplifier or the optical modulator is automatically adjusted, thereby suppressing the output saturation or distortion of a transmission apparatus.

According to the sixth aspect of the invention, since the electric field measuring apparatus further includes an RF amplification controller controlling the output of the RF amplifier on the basis of the detection result of the signal intensity detector, the intensity of the output signal of the antenna input to the optical modulator is automatically adjusted, thereby suppressing the output saturation or distortion of a transmission apparatus.

### BRIEF DESCRIPTION OF DRAWINGS

FIG. 1 is a diagram schematically illustrating an electric field measuring apparatus according to the invention.

FIG. 2 is a diagram illustrating the configuration of a head unit 2 and a controller unit 6 shown in FIG. 1.

FIG. 3 is a diagram illustrating an application of the configuration of the head unit 2 and the controller unit 6 shown in FIG. 1.

FIG. 4 is a diagram illustrating an example where a first receiver unit and a DC bias controller are assembled into the head unit shown in FIG. 1.

### DESCRIPTION OF EMBODIMENTS

Hereinafter, the invention will be described in detail with reference to applications.

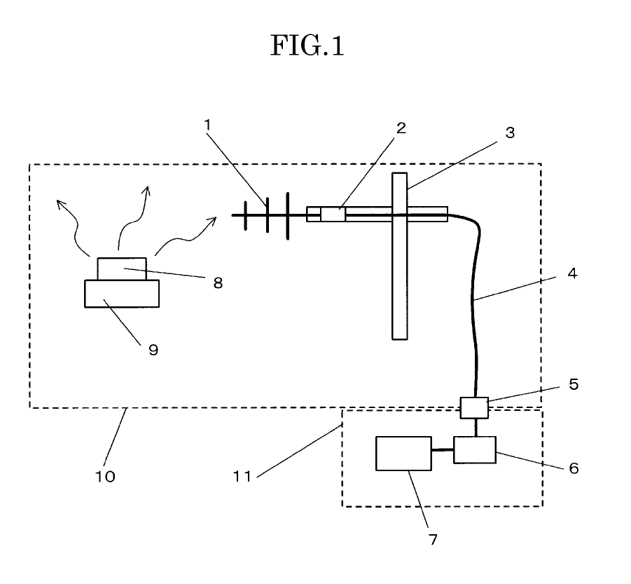

FIG. 1 is a diagram schematically illustrating an electric field measuring apparatus according to the invention. The electric field intensity of an electromagnetic wave (dotted arrows) generated from equipment under test (EUT) 8 installed in an area such as an anechoic chamber 10 in which electromagnetic waves are detected is measured. Reference numeral 9 represents a platform such as a turn table on which the equipment under test is placed.

The “area in which electromagnetic waves are detected” in the invention is not limited to the anechoic chamber, but means a free space such as an open site in which equipment under test is installed to detect electromagnetic waves generated from the equipment under test.

The expression, “outside the area in which electromagnetic waves are detected”, means an area in which the measurement of electromagnetic waves generated from the equipment under test is not hindered and examples thereof include a place outside an anechoic chamber, a place which is sufficiently separated from the equipment under test, and a space such as a measuring chamber to be described later in which a body section or a measuring device is arranged and electromagnetic waves generated from the equipment are prevented from leaking into the “area in which electromagnetic waves are detected”.

Hereinafter, an anechoic chamber and a measuring chamber will be described as an example.

An antenna 1 and a head unit 2 on which an optical intensity modulator having a Mach-Zehnder type optical waveguide is mounted are disposed inside an anechoic chamber 10. As described in PTL 1, the output signal of the antenna 1 is supplied to a modulation electrode of the optical intensity modulator to change the refractive index of the Mach-Zehnder type optical waveguide. By this change of the refractive index, the phase of optical waves propagating in the same optical waveguide is modulated and the optical intensity of optical waves output from the Mach-Zehnder type optical waveguide is modulated. Reference numeral 3 represents antenna positioning means for locating the antenna 1 at a predetermined position.

A traveling-wave-type optical modulator in which an optical waveguide and a modulator electrode are formed on a substrate having an electro-optical effect can be suitably used as the optical intensity modulator. Examples of the material of the substrate having an electro-optical effect include lithium niobate, lithium tantalate, PLZT (Lead Lanthanum Zirconate Titanate), and quartz-based materials. A Mach-Zehnder type optical waveguide can be formed on the substrate having an electro-optical effect by diffusing Ti or the like into the substrate surface through the use of a thermal diffusion method or a proton exchange method or forming a ridge-shaped convex portion thereon. The modulation electrode includes a signal electrode to which the output signal of an antenna is applied or a ground electrode and can be formed on the substrate through the use of formation of Ti and Au electrode patterns and gold plating. A dielectric buffer layer of SiO₂ or the like may be formed on the surface of the substrate on which the optical waveguide has been formed if necessary, thereby suppressing absorption or scattering of optical waves in an electrode formed above the optical waveguide.

Regarding a method of adjusting a bias point of the optical intensity modulator, it is possible to adjust the bias point of the optical intensity modulator by applying the resultant voltage, which is obtained by adding the DC bias voltage to the output voltage from the antenna, to the above-mentioned modulation electrode. An independent electrode for controlling the bias point may be provided in addition to the modulation electrode and the DC bias voltage may be applied to the electrode.

A measuring chamber 11 is adjacent to the outside of the anechoic chamber 10, and the measuring chamber 11 is provided with a controller unit 6 of the measuring apparatus controlling the head unit 2 and a measuring instrument 7 such as an EMI receiver. The head unit 2 and the controller unit 6 are connected to each other through a composite wire such as an optical fiber or a power supply line. Reference numeral 5 represents a low-pass filter blocking an AC signal formed in the power supply line and is configured so as for the AC signal not to enter the anechoic chamber when supplying the DC bias voltage or the like to the head unit from the controller unit 6.

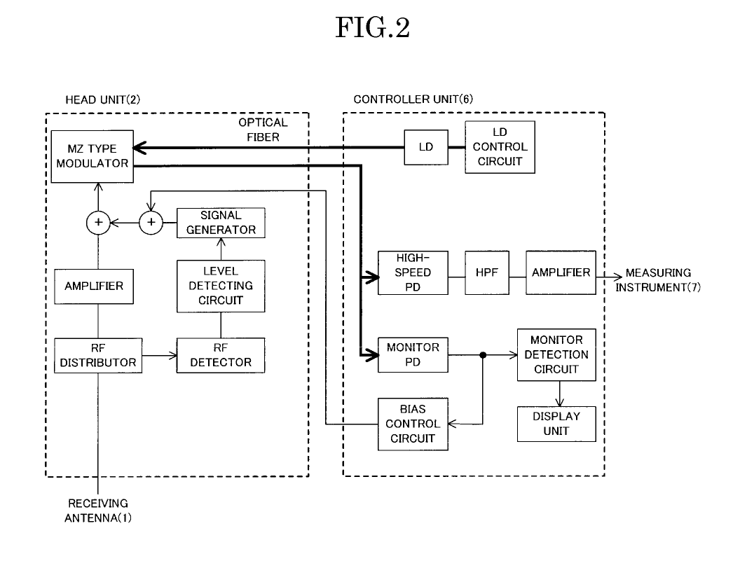

FIG. 2 is a diagram specifically illustrating the configurations of the head unit 2 and the controller unit 6.

The output signal (20 MHz or higher) from the receiving antenna is input to the head part 2 and the output signal is distributed to an amplifier and an RF detector by an RF distributor. The amplifier is an RF amplifier amplifying the output signal from the antenna. The RF detector detects the intensity of the output signal and introduces the detection signal into a level detecting circuit so as to check whether the intensity of the output signal is higher than a predetermined level. The RF detector and the level detecting circuit are combined to constitute a signal intensity detector. In addition, a signal generator generating a detection result signal on the basis of the detection result of the signal intensity detector is provided. For example, the signal generator modulates the intensity of an out-of-band low-frequency signal (lower than 20 MHz) of the output signal from the receiving antenna, when the level of the output signal is higher than a given level at which the optical modulator causes distortion.

The output signal from the amplifier as the RF amplifier, the detection result signal from the signal generator, and the DC bias voltage from the DC bias control circuit to be described later are added. The adder is indicated by reference sign + in the drawing. An optical intensity modulator (MZ type modulator) having a Mach-Zehnder type optical waveguide performing optical modulation on the basis of the output signal of the adder is provided.

The controller unit 6 is provided with a semiconductor laser (LD) as a light source unit and an LD control circuit as a control circuit driving the semiconductor laser. A continuous wave (CW) light wave of a given level is output from the semiconductor laser and is input to the MZ type modulator of the head unit 2 through an optical fiber.

The controller unit 6 is provided with a receiver unit (a high-speed PD and a monitor PD) receiving the optical output from the MZ type modulator as an optical intensity modulator. The receiver unit includes two receiving optical elements (PD) in FIG. 2, but may include a single PD and may separate the output signal from the PD into a high-frequency signal of 30 MHz or higher and a low-frequency signal of lower than 30 MHz.

The high-speed PD detects a signal of 30 MHz or higher corresponding to the output signal of the antenna, amplifies the signal passing through a high-pass filter (HPF) by the use of an amplifier, and outputs the amplified signal to the measuring instrument 7.

The monitor PD outputs a low-frequency signal of lower than 30 MHz. The low-frequency signal is branched into two components by a branching element such as a Bias-T and the branched components are output to the DC bias control circuit and the monitor detecting circuit, respectively. At this time, a transmission filter of a specific frequency band transmitting a signal on DC bias control of the optical modulator can be added to the front stage of the DC bias control circuit and a transmission filter of another specific frequency band transmitting the detection result signal generated from the signal generator can be added to the front stage of a monitor detection signal. These transmission filters may be built in the DC bias control circuit or the monitor detection signal.

The bias control circuit as the DC bias controller controls the DC bias voltage supplied to the optical intensity modulator on the basis of a variation in intensity of the output signal of the monitor PD as the receiver unit. The DC bias controller supplies the DC bias voltage to the optical intensity modulator through a power supply line.

Since the relationship curve (Vπ modulation curve) between the drive voltage and the optical intensity output in the optical intensity modulator is a sinusoidal function, the half point of the maximum optical intensity is generally set as the center of the bias point adjustment. The center point of the bias is not limited to this half point, but an intensity level lower than the half point may be employed by balance with the shot noise of the monitor PD.

Before measuring an electric field, the bias point is adjusted if necessary. Specifically, an optical wave from the LD of the light source unit is introduced into the optical intensity modulator, the bias voltage applied to the optical intensity modulator is swept, the value with which the output level of a monitor optical signal is the maximum is measured, and the bias voltage which is, for example, a half value of the maximum value is searched out.

When the bias point is adjusted in this way, an AC signal such as a low-frequency signal often used to control the bias point of the optical modulator in the related art is not necessary, thereby further suppressing the radiation of noise in the anechoic chamber. The AC signals such as the low-frequency signal can be superimposed to control the bias point, but it is preferable in this case that the signal for the DC bias control circuit and the signal for the monitor detection circuit be set to different frequencies in advance.

The detection result signal generated from the signal generator is detected from the output signal of the monitor PD as the receiver unit by the use of the monitor detection circuit. For example, when the output signal of the receiving antenna has a level higher than a predetermined level, the generated low-frequency signal (lower than 30 MHz) is detected and an excessive input state is displayed on the display unit on the basis of the detection result.

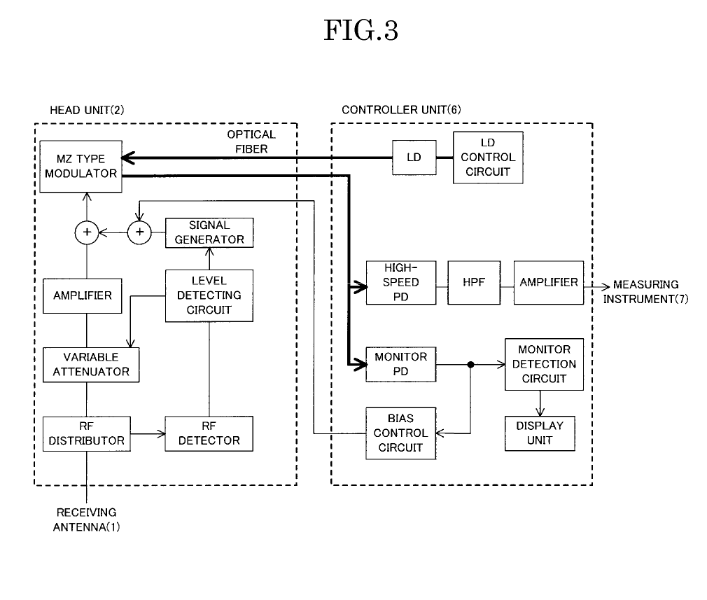

A method of automatically adjusting the intensity of the output signal of the antenna which is input to the RF amplifier or the optical modulator to suppress the output saturation or distortion of the transmission apparatus will be described below with reference to FIG. 3.

A variable attenuator attenuating the intensity of the output signal of the receiving antenna is disposed between the receiving antenna and the RF distributor or between the RF distributor and the amplifier as shown in FIG. 3. As shown in FIG. 2, when the intensity of the output signal of the receiving antenna is higher than a predetermined level on the basis of the result of the signal intensity detector including the RF detector and the level detecting circuit, the variable attenuator can be controlled to adjust the level of the signal input to the RF amplifier or the optical intensity modulator.

A configuration controlling the output of the RF amplifier on the basis of the result of the signal intensity detector may be provided as an RF amplification controller, whereby the variable attenuator may be removed.

When the intensity of the output signal of the antenna is automatically adjusted as described above, the level of the output signal input to the measuring instrument connected to the controller unit varies and it is thus difficult for the measuring instrument side to determine whether the variation is based on the automatic adjustment or based on the fall in level of the received electromagnetic wave itself. In order to solve this inconvenience, when the signal output is adjusted by the variable attenuator or the RF amplifier, a signal indicating the adjusted level may also be output as a part of the detection result signal from the signal generator and may be transmitted to the controller unit. The controller unit may extract the signal relevant to the adjusted level from the detection result signal and may calibrate the level of the output signal of the measuring instrument.

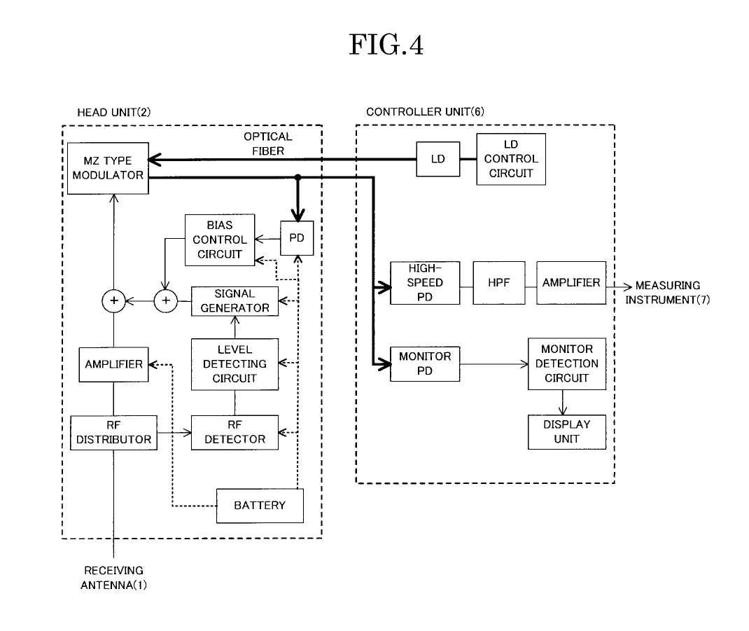

As shown in FIG. 4, the head unit 2 may be provided with a receiver element (PD) as the first receiver unit, a bias control circuit as the DC bias controller, and a battery as a power source supplying power to various components of the head unit and driving the components. The battery drives at least one of the amplifier as the RF amplifier, the RF detector or the level detecting circuit constituting the signal intensity detector, the signal generator, and the first receiver unit or the DC bias controller.

As shown in FIG. 4, by mounting the components associated with the DC bias control on the head unit and disposing the power source driving various components of the head unit in the head unit, the head unit 2 and the controller unit 6 are connected to each other through only the optical fiber, thereby achieving a simpler configuration and easily handling various components.

In FIG. 4, a part of the output wave from the MZ type modulator is branched by a branching unit and the branched output waves are input to the receiver element (PD) as the first receiver unit. The signal from the first receiver unit is input to the bias control circuit and is used to control the DC bias of the MZ type modulator, similarly to the examples shown in FIG. 2 or 3.

The MZ type modulator has a module structure in which it is mounted in a metal chassis. Accordingly, the first receiver unit shown in FIG. 4 may be disposed in the MZ type modulator as the optical intensity modulator and may be mounted in the same case. For example, the receiver unit disposed in a part of the modulator may be configured to monitor an optical radiation-mode from the adder of the Mach-Zehnder type waveguide, or various configurations or arrangements of monitoring an evanescent light wave of an optical wave propagating in the optical waveguide or the like may be employed. By housing the receiver unit in the module of the modulator, it is possible to reduce the size of the head unit and to suppress the generation of electromagnetic waves to the surrounding, thereby enabling higher-precision measurement.

### INDUSTRIAL APPLICABILITY

As described above, according to the invention, it is possible to provide an electric field measuring apparatus in which an output saturation or distortion state of a transmission apparatus due to an input signal level from an antenna can be easily checked and the measurement of an electric field in equipment such as an anechoic chamber is not hindered by noise from the measuring apparatus.

### REFERENCE SIGNS LIST

1: ANTENNA

2: HEAD UNIT

4: COMPOSITE WIRE (OPTICAL FIBER AND POWER SUPPLY LINE)

5: LOW-PASS FILTER

6: CONTROLLER UNIT

7: MEASURING INSTRUMENT

8: EQUIPMENT UNDER TEST

1. An electric field measuring apparatus that measures an electric field intensity of an electromagnetic wave generated from equipment under test installed in an area in which electromagnetic waves are detected, comprising
an antenna,
an RF amplifier amplifying an output signal of the antenna,
a signal intensity detector detecting whether an intensity of the output signal is higher than a predetermined level,
a signal generator generating a detection result signal on the basis of a detection result of the signal intensity detector,
a multiplexer multiplexing an output signal of the RF amplifier, the detection result signal, and a DC bias voltage, and
an optical intensity modulator having a Mach-Zehnder type optical waveguide performing an optical modulation operation on the basis of an output signal of the multiplexer are arranged inside the area, wherein
a light source unit, a receiver unit receiving an output light wave from the optical intensity modulator, a DC bias controller controlling the DC bias voltage supplied to the optical intensity modulator on the basis of a variation in intensity of an output signal of the receiver unit, and a display unit detecting a signal based on the detection result signal from the output signal of the receiver unit and displaying the detection result are arranged outside the area,
wherein an optical wave is introduced into the optical intensity modulator from the light source unit through an optical fiber,
wherein an optical wave is introduced into the receiver unit from the optical intensity modulator through an optical fiber, and
wherein the DC bias voltage is supplied to the optical intensity modulator from the DC bias controller through a power supply line.

2. An electric field measuring apparatus that measures an electric field intensity of an electromagnetic wave generated from equipment under test installed in an area in which electromagnetic waves are detected, comprising
an antenna,
an RF amplifier amplifying an output signal of the antenna,
a signal intensity detector detecting whether an intensity of the output signal is higher than a predetermined level,
a signal generator generating a detection result signal on the basis of a detection result of the signal intensity detector,
a multiplexer multiplexing an output signal of the RF amplifier, the detection result signal, and a DC bias voltage,
an optical intensity modulator having a Mach-Zehnder type optical waveguide performing an optical modulation operation on the basis of an output signal of the multiplexer,
a branching unit branching a part of an output light wave from the optical intensity modulator,
a first receiver unit receiving a branched light wave branched by the branching unit,
a DC bias controller controlling the DC bias voltage supplied to the optical intensity modulator on the basis of a variation in intensity of an output signal of the first receiver unit, and
a battery driving at least one of the RF amplifier, the signal intensity detector, the signal generator, the first receiver unit, and the DC bias controller are arranged inside the area,
wherein a light source unit, a second receiver unit receiving an output light wave from the optical intensity modulator, and a display unit detecting a signal based on the detection result signal from an output signal of the second receiver unit and displaying the detection result are arranged outside the area,
wherein an optical wave is introduced into the optical intensity modulator from the light source unit through an optical fiber, and
wherein an optical wave is introduced into the receiver unit from the optical intensity modulator through an optical fiber.

3. An electric field measuring apparatus that measures an electric field intensity of an electromagnetic wave generated from equipment under test installed in an area in which electromagnetic waves are detected, comprising
an antenna,
an RF amplifier amplifying an output signal of the antenna,
a signal intensity detector detecting whether an intensity of the output signal is higher than a predetermined level,
a signal generator generating a detection result signal on the basis of a detection result of the signal intensity detector,
a multiplexer multiplexing an output signal of the RF amplifier, the detection result signal, and a DC bias voltage,
an optical intensity modulator having a Mach-Zehnder type optical waveguide performing an optical modulation operation on the basis of an output signal of the multiplexer,
a first receiver unit being built in the optical intensity modulator and monitoring an output optical intensity of the optical intensity modulator,
a DC bias controller controlling the DC bias voltage supplied to the optical intensity modulator on the basis of a variation in intensity of an output signal of the first receiver unit, and
a battery driving at least one of the RF amplifier, the signal intensity detector, the signal generator, the first receiver unit, and the DC bias controller are arranged inside the area,
wherein a light source unit, a second receiver unit receiving an output light wave from the optical intensity modulator, and a display unit detecting a signal based on the detection result signal from an output signal of the second receiver unit and displaying the detection result are arranged outside the area,
wherein an optical wave is introduced into the optical intensity modulator from the light source unit through an optical fiber, and
wherein an optical wave is introduced into the receiver unit from the optical intensity modulator through an optical fiber.

4. The electric field measuring apparatus according to claim 1, wherein the detection result signal has a frequency less than 30 MHz.

5. The electric field measuring apparatus according to claim 1, further comprising an attenuator attenuating the intensity of the output signal of the antenna on the basis of the detection result of the signal intensity detector.

6. The electric field measuring apparatus according to claim 1, further comprising an RF amplification controller controlling the output of the RF amplifier on the basis of the detection result of the signal intensity detector.

7. The electric field measuring apparatus according to claim 2, wherein the detection result signal has a frequency less than 30 MHz.

8. The electric field measuring apparatus according to claim 3, wherein the detection result signal has a frequency less than 30 MHz.

9. The electric field measuring apparatus according to claim 2, further comprising an attenuator attenuating the intensity of the output signal of the antenna on the basis of the detection result of the signal intensity detector.

10. The electric field measuring apparatus according to claim 3, further comprising an attenuator attenuating the intensity of the output signal of the antenna on the basis of the detection result of the signal intensity detector.

11. The electric field measuring apparatus according to claim 4, further comprising an attenuator attenuating the intensity of the output signal of the antenna on the basis of the detection result of the signal intensity detector.

12. The electric field measuring apparatus according to claim 2, further comprising an RF amplification controller controlling the output of the RF amplifier on the basis of the detection result of the signal intensity detector.

13. The electric field measuring apparatus according to claim 3, further comprising an RF amplification controller controlling the output of the RF amplifier on the basis of the detection result of the signal intensity detector.

14. The electric field measuring apparatus according to claim 4, further comprising an RF amplification controller controlling the output of the RF amplifier on the basis of the detection result of the signal intensity detector.

15. The electric field measuring apparatus according to claim 5, further comprising an RF amplification controller controlling the output of the RF amplifier on the basis of the detection result of the signal intensity detector.
